(19) United States
(12) Patent Application Publication
(10) Pub. No.: US 2008/0263592 A1
(43) Pub. Date: Oct. 23, 2008

(54) SYSTEM FOR VIDEO CONTROL BY DIRECT MANIPULATION OF OBJECT TRAILS

(75) Inventors: Donald G. Kimber, Foster City, CA (US); Anthony Eric Dunnigan, Berkeley, CA (US); Andreas Girgensohn, Palo Alto, CA (US); Frank M. Shipman, College Station, TX (US); Althea Ann Turner, Menlo Park, CA (US); Tao Yang, Xi'an (CN)

Correspondence Address: FLIESLER MEYER LLP, 650 CALIFORNIA STREET, 14TH FLOOR, SAN FRANCISCO, CA, 94108, US

(73) Assignee: FUJI XEROX CO., LTD., Tokyo (JP)

(21) Appl. No.: 11/838,659

(22) Filed: Aug. 14, 2007

Related U.S. Application Data
(60) Provisional application No. 60/912,662, filed on Apr. 18, 2007.

(51) Int. Cl. G06F 3/00

(52) U.S. Cl. 725/38

(57) ABSTRACT

One embodiment is a method for an interaction technique allowing users to control nonlinear video playback by directly manipulating objects seen in the video playback, comprising the steps of: tracking a moving object on a camera; recording a video; creating an object trail for the moving object which corresponds to the recorded video; allowing the user to select a point in the object trail; and displaying a frame in the recorded video that corresponds with the selected point in the object trail.

### CLAIM OF PRIORITY

This application claims priority to U.S. Provisional Patent Application 60/912,662 filed Apr. 18, 2007, entitled “SYSTEM FOR VIDEO CONTROL BY DIRECT MANIPULATION OF OBJECT TRAILS,” inventors Donald G. Kimber, et al., which is hereby incorporated by reference.

### BACKGROUND OF THE INVENTION

1. Field of the Invention

This invention is related to interaction techniques that allow users to control nonlinear video playback by directly manipulating objects seen in the video.

2. Description of the Related Art

An important feature of digital video is that it supports nonlinear viewing in whatever manner is most suitable to a given task. Particularly for purposes such as process analysis, sports analysis or forensic surveillance tasks, some portions of the video may be skimmed over quickly while other portions are viewed repeatedly many times, at various speeds, playing forward and backward in time. Scrubbing, a method of controlling the video frame time by mouse motion along a time line or slider, is often used for this fine level control, allowing a user to carefully position the video at a point where objects or people in the video are in certain positions of interest or moving in a particular way. In video “scrubbing,” the user adjusts the playback time by moving the mouse along a slider.

### SUMMARY OF THE INVENTION

A method for an interaction technique allowing users to control nonlinear video playback by directly manipulating objects seen in the video playback, comprising the steps of: tracking a moving object on a camera; recording a video; creating an object trail for the moving object which corresponds to the recorded video; allowing the user to select a point in the object trail; and displaying a frame in the recorded video that corresponds with the selected point in the object trail.

### BRIEF DESCRIPTION OF THE DRAWINGS

Preferred embodiments of the present invention will be described in detail based on the following figures, wherein:

FIG. 1 shows an example of one embodiment tracking a person moving through a hallway;

FIG. 2 shows the system architecture for one embodiment;

FIG. 3 shows an example of one embodiment tracking two vehicles and a pedestrian;

FIG. 4 shows an example of tracking multiple people on a soccer field;

FIG. 5 shows an example of one embodiment displaying video from several different hallways;

FIG. 6 shows an example of a floor plan and camera locations;

FIG. 7 shows the system architecture for one embodiment;

FIG. 8 shows an example of one embodiment;

FIG. 9 shows an example of one embodiment displaying video from several different hallways; and

FIG. 10 shows a distance function that includes weighted distances in location and time as well as a cost for changing temporal direction during a single dragging event.

### DETAILED DESCRIPTION OF THE INVENTION

One embodiment of the invention is an interaction technique that allows users to control nonlinear video playback by directly manipulating objects seen in the video. Embodiments of the invention are superior to variable-scale scrubbing in that the user can concentrate on interesting objects and does not have to guess how long the objects will stay in view. This interaction technique relies on a video tracking system that tracks objects in fixed cameras, maps them into 3D space, and handles hand-offs between cameras. In addition to dragging objects visible in video windows, users may also drag iconic object representations on a floor plan. In that case, the best video views are selected for the dragged objects.

Scrubbing and off-speed playback, such as slow motion or fast forward, are useful but have limitations. In particular, no one playback speed, or scale factor for mapping mouse motion to time changes, is appropriate for all tasks or all portions of video. Adding play speed controls and the ability to zoom in on all or some of the timeline helps but can be confusing and distracting from the task at hand. Instead of users directly controlling what they view, they spend time focusing on control features of the interface. Some researchers have tried to address this by using variable speed playback with speed determined automatically by the amount of motion, or new information at each time of the video. These schemes may be thought of as re-indexing the video from time t to some function s(t), where for example s(t) is the cumulative information by time t, or the distance a tracked object moved. Applicants have experimented with such schemes for variable scale scrubbing, where in addition to a time slider, the user is provided with another slider for s. Since there are various measures of change, or various objects could be tracked, multiple sliders can be provided.

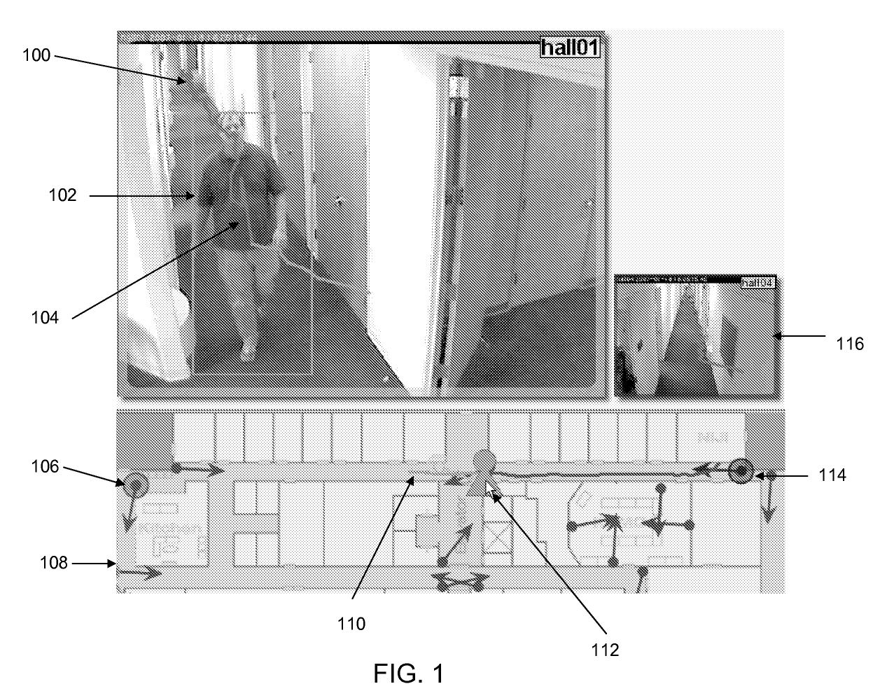

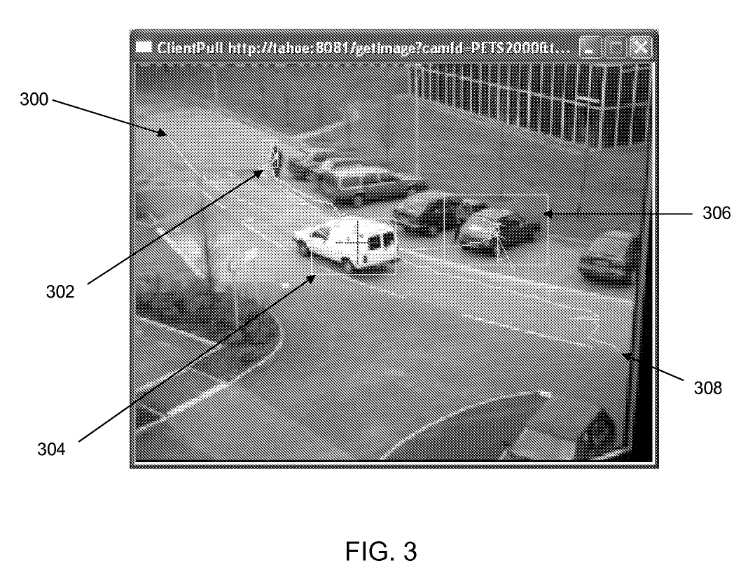

However, rather than indirect scrubbing control by multiple sliders, a more natural interface is based on the reach-through-the-screen metaphor—simply letting users directly grab and move objects along their trails. See J. Foote, Q. Liu, D. Kimber, P. Chiu and F. Zhao, “Reach-through-the-screen: A New Metaphor for Remote Collaboration,” Advances in Multimedia Information Processing, PCM 2004, pp. 73-80, Springer, Berlin, 2004. FIG. 1 shows an embodiment of the invention where the user may grab and move objects along their trails directly in a video window 116 or in a floor plan view 108 which schematically indicates positions of people by icons. For example, a user reviewing surveillance video may drag a person 104 along their trail 100 to view video at any given point, or, as in FIG. 3, drag a parked car 306 to move to the points in the video where the car was parked or left. The effect of the interface is to shift user experience from passively watching time-based video to directly interacting with it. The box 102 around the moving object 104 (in this example a person 104), assists the user in isolating the moving object 104 from the background of the video. The floor plan view 108 shows the moving object 112, the object trail 110, and camera view angles 106 and 114. The user interface also shows other camera views of the moving object such as 116.

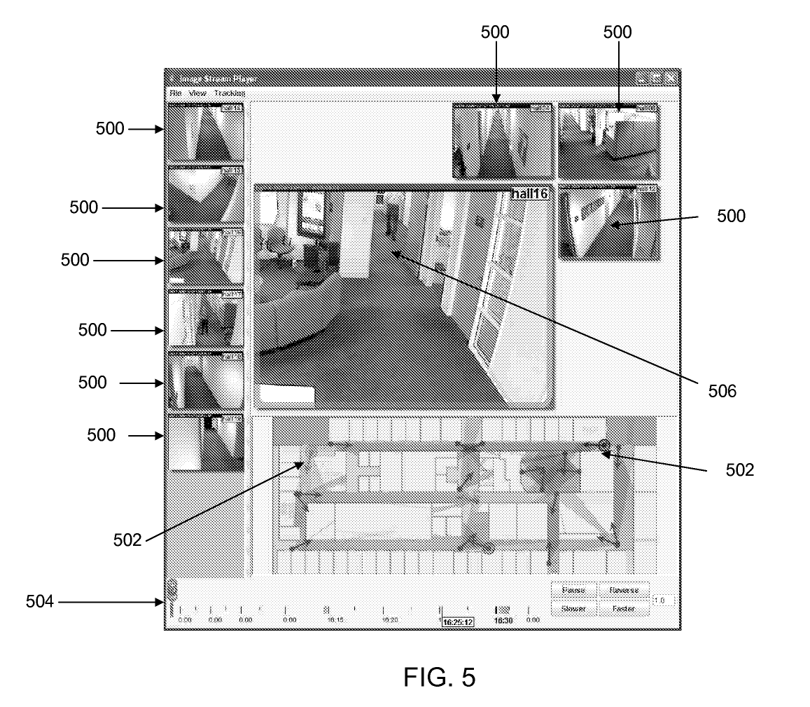

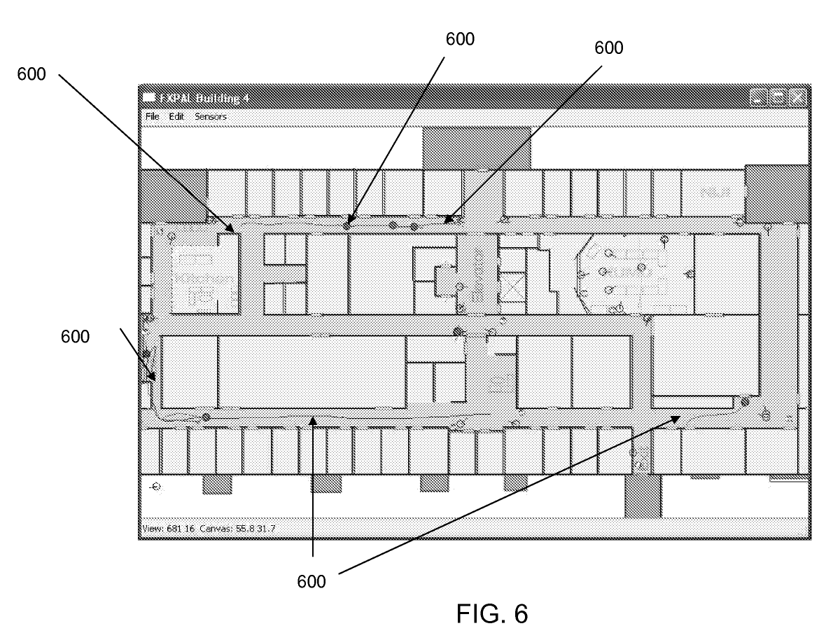

In FIG. 5, numerous cameras 500 are located throughout the floor plan 502. The best camera 506 is enlarged to allow the user to see the moving object from the best angle. In FIG. 6, a floor plan shows the object trail for a moving object 600.

Processes that are automatic in embodiments of the current invention include tracking and labeling. Embodiments of the current invention use world geometry to enable tracking across cameras.

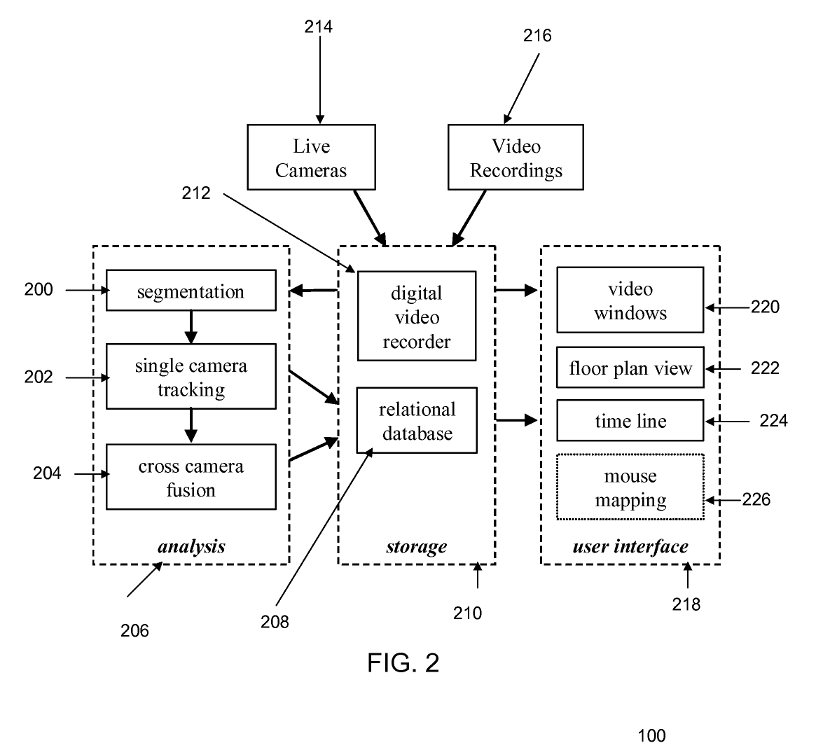

Some embodiments of the direct video manipulation methods require metadata defining the trails of people and objects in the video. Additionally, manipulation of floor plan views and cross-camera manipulation requires association of objects across cameras as well as world coordinate trajectories for some embodiments. This metadata can be acquired by various means. One embodiment uses a video system called DOTS (Dynamic Object Tracking System) developed at Fuji Xerox Co., Ltd. to acquire metadata. See A. Girgensohn, F. Shipman, T. Dunnigan, T. Turner, and L. Wilcox, “Support for Effective Use of Multiple Video Streams in Security,” Proc. of the Fourth ACM International Workshop on Video Surveillance & Sensor Networks, Santa Barbara, Calif., October 2006. One embodiment's overall system architecture is shown in FIG. 2, and is comprised of video capture (or live cameras) 214 or import (or video recordings) 216, video analysis 206, and user interface 218 playback tools. Analysis consists of segmentation 200, single camera tracking 202, and cross camera fusion 204. Storage 210 consists of relational database 208 and digital video recorder 212. The user interface 218 consists of video windows 220, floor plan view 222, time line 224, and mouse mapping 226. Analysis algorithms used in some embodiments are described in more detail in T. Yang, F. Chen, D. Kimber, and J. Vaughan, “Robust People Detection and Tracking in a Multi-Camera Indoor Visual Surveillance System,” paper submitted to ICME 2007.

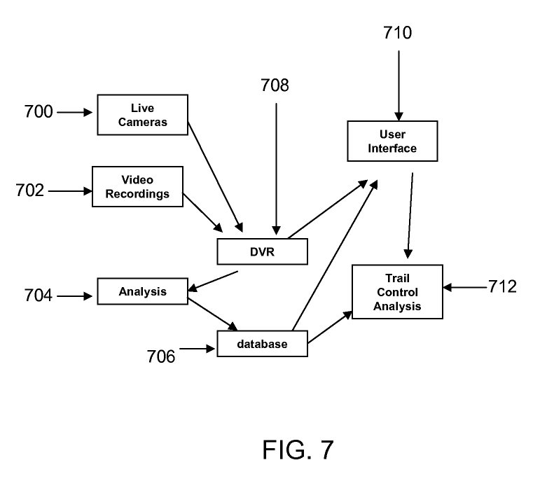

An alternative embodiment's system architecture is shown in FIG. 7. The architecture consists of live cameras 700, video recordings 702, analysis 704, database 706, digital video recorder 708, user interface 710, and trail control analysis 712.

### Single Camera Video Analysis

The requirement of the analysis is to produce object tracks suitable for indexing. At each frame time t, each tracked object is associated with an image region bounding box, which is entered into a database with an identifier for that object.

The first processing step is segmenting people from the background. A Gaussian mixture model approach is used for pixel level background modeling. See C. Stauffer, W. Eric, and L. Grimson, “Learning patterns of activity using real-time tracking,” IEEE Trans. on Pattern Analysis and Machine Intelligence, Volume 22, Issue 8, pp. 747-757, 2000. For foreground segmentation that is robust to shadows, similar colors, and illumination changes, a novel feature-level subtraction approach is used. First, the foreground density around each pixel is used to determine a candidate set of foreground pixels. Then, instead of comparing the difference in intensity value of each pixel, the difference is found from the neighborhood image using a normalized cross-correlation computed using the integral image method.

For single camera tracking in the data association module, a correspondence matrix is used to classify an object's interactions with other objects into five classes: Appear, Disappear, Continue, Merge and Split. See R. Cucchiara, C. Grana, and G. Tardini, “Track-based and object-based occlusion for people tracking refinement in indoor surveillance,” Proc. ACM 2nd International Workshop on Video Surveillance & Sensor Networks, pp. 81-87, 2004. Identity maintenance is handled for occlusion by a track-based Bayesian segmentation algorithm using appearance features. Merges and Splits are entered into the database so that if tracked object regions are merged to form new regions, which are subsequently split to form other regions, it is possible to determine which future regions are descendents and, hence, candidates to be the tracked object. If a region is split into multiple regions, it is entered into the database as a parent of each of those regions. Similarly if multiple regions are merged into a new region, each of them is entered as a parent of the new region. The parent (pRegion, cRegion) relation defines a partial ordering on regions. The transitive closure of parent( . , . ) defines an ancestor (aRegion, dRegion) relation, indicating that region aRegion is an ancestor of the descendent region dRegion. The significance of the ancestor relation is that it indicates the possibility that dRegion is an observation of the same object as aRegion.

### Multiple Camera and Floor Plan-Based Tracking

To support manipulation across different video views, or on a schematic floor plan, one embodiment maps object positions in video-to-world coordinates, and determines associations of objects across cameras. In one embodiment, cameras are mounted near the ceiling with oblique downward views. Estimates of world position are based on the assumption that the bottoms of the bounding boxes are from points on the floor plane. A model of building geometry is used to filter out nonsensical results, for example, where the resulting world coordinates would be occluded by walls.

Cross-camera object association is handled by searching for a hypothesis H of world object trajectories which maximizes the a posteriori probability P(H|O) of H given observations O, where O is the set of all tracked object regions in all cameras. This is equivalent to maximizing P(O|H)P(H) over H. The priors P(H) incorporate a Gauss-Markov object dynamics model and learned probabilities for object appearance and disappearance. P(O|H) is based on a Gaussian error model for an object at a given world position being tracked at a given image position. A result of the fusion is an estimate of world trajectories for tracked objects and an association of objects with tracked regions in images.

### User Interface Components

User interface components include multi-stream video player that combines video displays at different resolutions, a map indicating positions of cameras and tracked objects, and a timeline for synchronously controlling all video displays. See A. Girgensohn, F. Shipman, T. Dunnigan, T. Turner, and L. Wilcox, “Support for Effective Use of Multiple Video Streams,” Security. Proc. of the Fourth ACM International Workshop on Video Surveillance & Sensor Networks, Santa Barbara, Calif., October 2006. The system automatically selects video displays and enlarges more important displays (e.g., those showing a tracked object better; see FIG. 1).

### Direct Manipulation of Objects

Given the object trail information, whether in a single camera view or a floor plan view, embodiments support the use of the mouse to move objects to different points on their trails. This controls the video playback position for all video views, such that the playback position is set to the time when the object occupied the position selected by the user.

In any view, clicking on an object selects the object and shows its trajectory. If the mouse click is not over an object, the system determines a set of candidate trajectories in the neighborhood of the click. Users may select a candidate by rapidly clicking multiple times to cycle through candidates. Once an object is selected, it may be dragged to different positions. The object motion is constrained by the object trail such that the object can only be moved to locations where it was observed at some time.

Picking the point in time where the object was closest to the mouse position can have undesirable consequences in situations where objects cross their own trail or where they loop back. In such cases, the method will create discontinuities in playback as the location closest to the pointer jumps between the different parts of the object's track. Additionally, when an object reaches the location where it starts to retrace its path, it is ambiguous whether dragging the pointer back indicates scrubbing forward or backward in time.

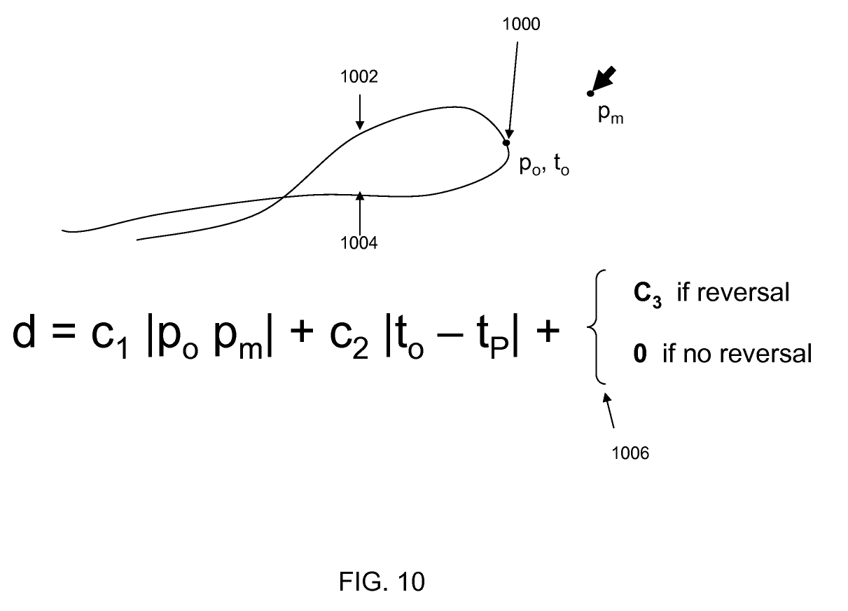

To solve these problems, a distance function is used that includes weighted distances in location and time as well as a cost for changing temporal directions during a single dragging event. The following equation, shown in FIG. 10, determines the distance for the object position p₀, the mouse position pₘ, the object time t₀, and the video time tᵥ. The constant c₃ is added if the object time tᵥ would cause a reversal of playback direction. In response to a mouse movement to pₘ, the video time is changed from tᵥ to the to that minimizes d.

$$d = {c}_{1} \vert \vec{{p}_{o} {p}_{m}} \vert + {c}_{2} \vert {t}_{o} - {t}_{v} \vert + \{ \begin{matrix}0 \\ {c}_{3}\end{matrix}$$

One problem with this approach is that the user may have to drag the cursor fairly far to overcome the cost associated with changing time and/or direction of playback. To overcome this, the value of c₁ is doubled for every 0.5 seconds during which no new video frame has been displayed.

To indicate to the user which objects in the video may be dragged and which locations they may be dragged to, object trails may be shown in the views. Depending on the particular video and task, it is appropriate to show all trails for an extended period of time, trails for only objects visible at the current play time, trails for only an object currently being dragged, or for the object currently under the mouse. Also, for complex scenes, it may be desirable to show only a portion of trails for a fixed time into the future or past. These settings are configurable and may be temporarily overridden by key presses.

### Direct Manipulation in the Video Window

The trailblazing interface method may be used in video and floor plan views. However, for some applications, the floor plan views may not be available either because camera calibrations are unavailable, or because the scenes are too complex for robust tracking analysis with cross-camera fusion. The method may still be applied to the video windows in those cases, however.

The method is particularly useful when different objects are moving with widely varying timescales at different times. The scene in FIG. 3 (from the PETS 2000 test set) includes a pedestrian 302, a moving car 304, and a parked car 306. A user may drag the pedestrian 302 to any position along the trail 308, and will see the white car 304 move quickly. The user also may drag the parked car 306 to move back to the time it was parked or ahead to the time it moves from its spot.

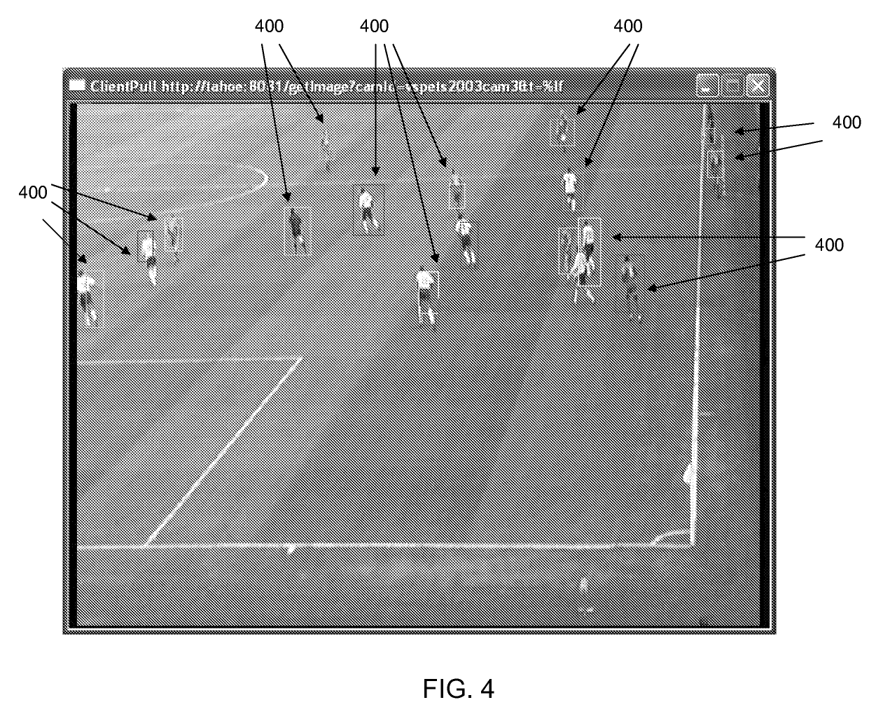

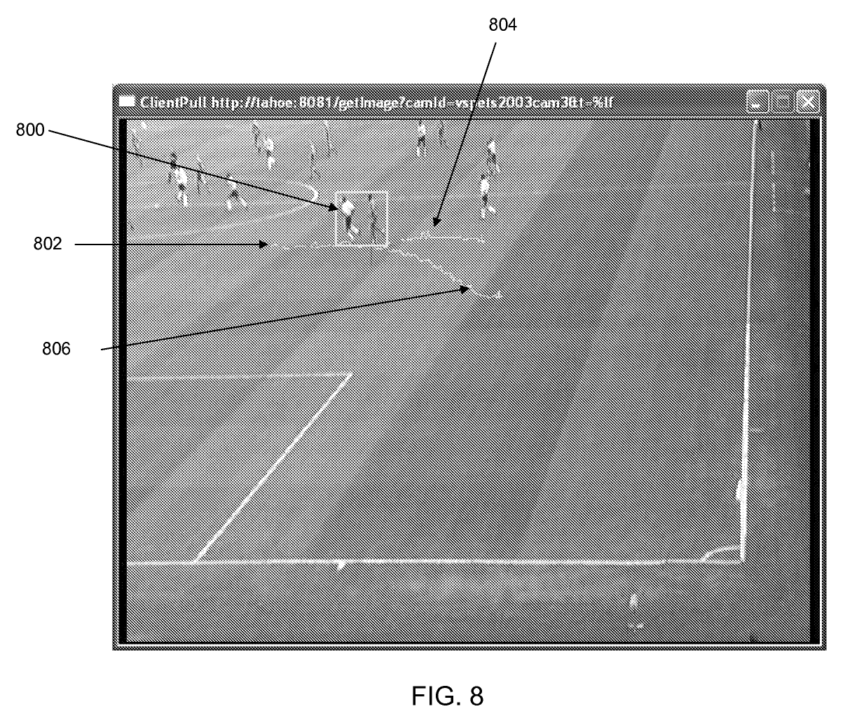

For complex scenes where tracking cannot robustly maintain object identity or in which occlusion causes regions to be merged and split, the method may still be used effectively by using the ancestry chain. In FIG. 4, a large number of moving objects are in the camera view, in this case football players 400 who each have their own object trails, but for ease of viewing the object trails are not shown on the display screen. FIG. 8 shows a football scene where two players have moved close to each other 800 and the tracking algorithm has merged their regions. Putting the mouse over the players shows the merged tracking region 802 and the path for a few seconds into the future 802 and past 806. The user may drag back along the path and when the mouse is moved to a position along the trail of either of the merged players, the video will move to the time the player is at the desired location. Often when the user drags an object with the mouse, they reach a point where the region tracking the object splits 804 and 806—for example when people are walking near each other, and are grouped by the tracker as a single region, and the people then split apart. In this case, the user is free to drag the mouse along the path of whichever object the user wants to follow, and the playtime will be set accordingly.

### Optical Flow Based Dragging in Video

The basic method of scrubbing video may be used even when object tracking is not feasible. Optical flow can be used to compute flow vectors at various points of the image with texture (for example using the Lucas-Kanade tracker found in OpenCV). A ‘local point trajectory’ can be determined by the optical flow around that point, or at a nearby point with texture. Dragging the mouse will move time at a rate determined by the inner-product of the mouse motion and the nearby optical flow. Dragging in the direction of flow moves the video forward, dragging back moves the video backwards. This method could be used even when the camera is not fixed. For example, consider a panoramic video produced by panning a camera slowly around by 360 degrees. The direct manipulation control of video playback would give the user a very similar experience to dragging the view in a panoramic image viewer such as QuickTime VR (“QTVR”), yet would not require any image stitching or warping to generate a panoramic. Similarly, if the video was collected by pointing a camera towards a central location while moving the camera around it, this method for scrubbing video would give the user an experience similar to viewing an object movie in QTVR.

### Direct Manipulation in the Floor Plan

Dragging objects on a map based on their movement in location is another natural mode of interacting with video. As an object is placed in different positions along its trail, the playback position of all video displays is skipped to the corresponding time. Among all available video views, the ones that are displayed show the selected object best 102. The best video view is shown in a larger size 102. As the object is dragged, the video views are replaced. As the time changes, a smaller window (such as 116) may be enlarged and may be reduced in size 102.

The floor plan ties together multiple video displays. In addition to dragging an object within the floor plan or a single video display, the object may also be dragged between video displays or from the floor plan to a video display. The system interprets this as a request to locate a time where the object is visible in the destination video display at the final position of the dragging action.

### Selection Among Candidate Trails

It is often desirable to determine when an object reached a particular point or to see all objects that were near that point. In addition to dragging the selected object, the user may also click on a position not occupied by an object. That will move the selected object close to the selected position. If no object was selected, one of the objects that were near that point will be selected. Repeatedly clicking on the same position will cycle through candidate times and objects.

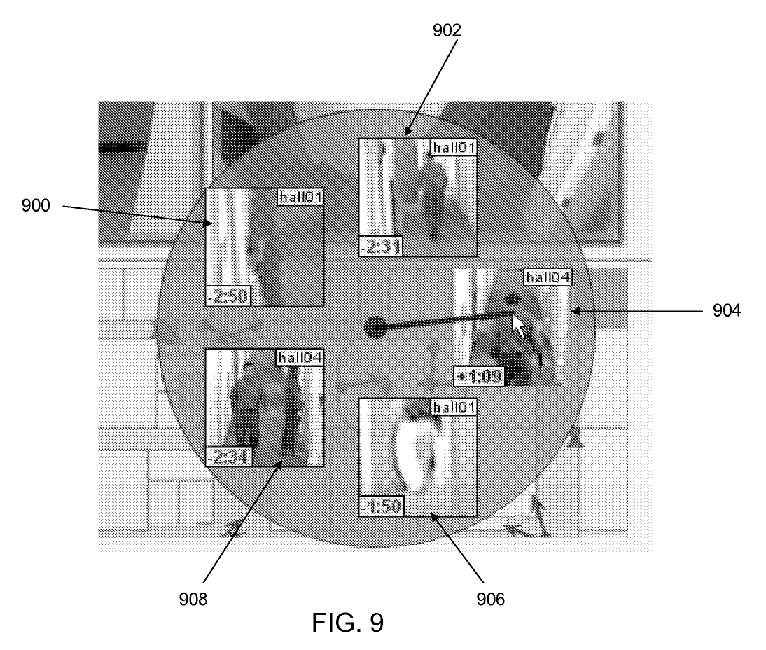

Right-clicking on a position displays a radial menu presenting the candidates (see FIG. 9). For each candidate, the video image is cropped to the outline of the object to provide a good view. Different times of the camera in hall 1 are displayed 900, 902, and 906, and different times of the camera in hall 4 are displayed 904 and 908. After selecting one of the candidates, the corresponding object is selected and the video display skips to the corresponding time.

Direct manipulation can be used to control playback, which inherently corresponds to querying the database for metadata about object motion. (Although, importantly, the user should not think of it as doing database access or a query—they are simply directly indicating what they want to see.) The queries described so far are all ‘read queries’ in that they do not change the database. Some of these methods could also be used to let a user indicate how a database should be changed. For example, consider the situation where a scene is complex enough that the tracker cannot accurately maintain identity of tracked objects, but maintains a dependency chain (i.e. an ancestry relation as described earlier). A user may drag an object in the video corresponding to a person they want to follow. When the person of interest approaches other people, so that the tracked regions of the people merge into one, the user may continue to drag the group of people, until the person of interest leaves the group. At that point there will be multiple trails leaving the group, but the user often can see which is the person they are interested in. By dragging along that trail, the user is implicitly asserting that it is the person of interest. This can be used to update the database with the correct identity metadata. Of course the system could provide a mechanism for the user to explicitly indicate they are making such an assertion so they do not inadvertently modify the database. For example dragging with a meta key pressed could be a command to indicate the user is asserting the trail of a single person.

One embodiment is a system that allows users to control video playback by directly manipulating objects shown in the video. This interaction technique has several advantages over scrubbing through video by dragging a slider on a time line. First, because tracked objects can move at different speeds (e.g., pedestrians and cars), it is more natural for the user to manipulate the object directly instead of a slider. Second, a slider does not provide a sufficiently fine control for long videos. Third, the start and end of an interval of interest where an object is visible is apparent to the user. Finally, the technique can also be used as a means for retrieval (e.g., check when a person was in a particular position or find all people who were near that position). While the system relies on tracking, it deals with merging and splitting of objects through chains of ancestors for tracked objects.

The foregoing description of embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps preformed in the embodiments of the invention disclosed can be performed in alternate orders, certain steps can be omitted, and additional steps can be added. The embodiments where chosen and described in order to best explain the principles of the invention and its practical application, thereby enabling others skilled in the art to understand the invention for various embodiments and with various modifications that are suited to the particular used contemplated. It is intended that the scope of the invention be defined by the claims and their equivalents.

What is claimed is:

1. A method for an interaction technique allowing users to control nonlinear video playback by directly manipulating objects seen in the video playback, comprising the steps of:
tracking a moving object on a camera;
recording a video;
creating an object trail for the moving object which corresponds to the recorded video;
allowing the user to select a point in the object trail;
displaying the point in the recorded video that corresponds with the selected point in the object trail.

2. The method of claim 1, further comprising the step of:
displaying the object trail to a user.

3. The method of claim 1, further comprising the step of:
allowing the user to drag the moving object along the object trail in the recorded video.

4. The method of claim 1, wherein the interaction technique relies on a video tracking system that tracks objects in fixed cameras, maps them into 3D space, and handles hand-offs between cameras.

5. The method of claim 4, wherein the users can drag iconic object representations on a floor plan.

6. The method of claim 5, wherein a best video view is selected for a dragged object.

7. The method of claim 1, wherein world geometry is used to enable track across cameras.

8. The method of claim 1, wherein metadata defines the trails of people and objects in the video.

9. The method of claim 1, wherein at each frame time, each tracked object is associated with an image region bounding box, which is entered into a database with an identifier for the tracked object.

10. The method of claim 1, wherein a Gaussian mixture model approach is used for pixel level background modeling to segment people from the background for single camera video analysis.

11. The method of claim 1, wherein foreground segmentation is achieved by analyzing foreground density around each pixel to determine a candidate set of foreground pixels and the difference is found from the neighborhood image using a normalized cross-correlation computed using an integral image method.

12. The method of claim 1, wherein a correspondence matrix is used to classify an object's interactions with other objects for single camera tracking in a data association module.

13. The method of claim 12, wherein classes comprise Appear, Disappear, Continue, Merge, and Split.

14. The method of claim 1, wherein identity maintenance is handled by occlusion by a track-based Bayesian segmentation algorithm using appearance features.

15. The method of claim 13, wherein Merges and Splits are entered into a database.

16. A computer-readable medium containing instructions stored thereon, wherein the instructions comprise an interaction technique allowing users to control nonlinear video playback by directly manipulating objects seen in the video playback, comprising:
tracking a moving object on a camera;
recording a video;
creating an object trail for the moving object which corresponds to the recorded video;
allowing the user to select a point in the object trail;
displaying the point in the recorded video that corresponds with the selected point in the object trail.

17. The computer-readable medium of claim 16, further comprising:
displaying the object trail to a user.

18. The computer-readable medium of claim 16, further comprising:
allowing the user to drag the moving object along the object trail in the recorded video.

19. The computer-readable medium of claim 16, wherein the interaction technique relies on a video tracking system that tracks objects in fixed cameras, maps them into 3D space, and handles hand-offs between cameras.

20. The computer-readable medium of claim 16, wherein the users can drag iconic object representations on a floor plan.

21. The computer-readable medium of claim 16, wherein a best video view is selected for a dragged object.

22. The computer-readable medium of claim 16, wherein world geometry is used to enable track across cameras.

23. A method for an interaction technique allowing users to control nonlinear video playback by directly manipulating optical flow around a point with texture in the video playback, comprising the steps of:
recording a video;
creating an optical flow around a point with texture which corresponds to the recorded video;
allowing the user to select a point in the optical flow;
displaying the point in the recorded video that corresponds with the selected point in the optical flow.

24. A computer-readable medium containing instructions stored thereon, wherein the instructions comprise:
an interaction technique allowing users to control nonlinear video playback by directly manipulating optical flow around a point with texture in the video playback, comprising the steps of:
recording a video;
creating an optical flow around a point with texture which corresponds to the recorded video;
allowing the user to select a point in the optical flow;
displaying the point in the recorded video that corresponds with the selected point in the optical flow.
